(19) United States
(12) Patent Application Publication
(10) Pub. No.: US 2005/0117733 A1
(43) Pub. Date: Jun. 2, 2005

(54) Communication management system for managing multiple incoming communications, such as from one graphical user interface

(76) Inventors: Ian Widger, Bellevue, WA (US); Michael B. Fischer, Renton, WA (US); Mark H. Sher, Redmond, WA (US); Douglas J. Christiansen, Duval, WA (US)

Correspondence Address: PERKINS COIE LLP;PATENT-SEA, P.O. BOX 1247, SEATTLE, WA, 98111-1247, US

(21) Appl. No.: 10/911,225

(22) Filed: Aug. 3, 2004

Related U.S. Application Data
(63) Continuation of application No. 09/966,218, filed on Sep. 28, 2001, now abandoned.
(60) Provisional application No. 60/235,989, filed on Sep. 28, 2000.

(51) Int. Cl. H04M 1/56; G06F 7/00; G06F 17/30; H04M 15/06

(52) U.S. Cl. 379/221.05; 379/202.01; 379/201.01; 707/10

(57) ABSTRACT

A system and method is described for managing communications, including telephone calls, to a user. In one embodiment, the user configures a telephone services provider system (TSPS) to handle incoming calls based upon information stored in a contact management software database. The user may provide a handling code in part of an unused data field in the standard contact management software database. The TSPS interfaces with the contact management software using open application programming interfaces (APIs). The user views and manages communications, including incoming calls, caller contact information, and call histories from a user interface. In one embodiment, the user interface is the standard contact management software interface.

### CROSS-REFERENCE TO RELATED APPLICATION(S)

This application is a continuation of U.S. patent application Ser. No. 09/966,218 filed Sep. 28, 2001, which claims priority from U.S. Provisional Patent Application Ser. No. 60/235,989, titled “Telephone Call Handling System and Method, Such as a Call Screening System Employing Standard Contact Management Software,” filed Sep. 28, 2000, which applications are incorporated herein by reference.

### BACKGROUND

People receive large numbers of communications daily. The communications include multiple mediums, for example voice calls, emails and facsimiles (faxes). Most individuals now have multiple “destinations” for communications within each medium. For example, an individual may have three telephone numbers, three email accounts, and two fax numbers. Communication modes and devices are proliferating. The convenience and utility that was originally intended to result from this communication capability is in danger of being overcome by the complexity of managing this same capability. Voice communication alone can become very complicated.

Traditional voicemail systems, and other systems that record audio messages retrievable by telephone, require a user to have access to a telephone or related device and an appropriate telecommunications network to retrieve messages. Additionally, different voicemail systems require different procedures and inputs to retrieve messages. Voice message systems are designed and deployed based on the requirements of the environment in which they operate. As a result there are numerous voice message systems with a wide range of capabilities.

### BRIEF DESCRIPTION OF THE DRAWINGS

FIG. 1 is block diagram illustrating an example of a system employing aspects of the invention.

FIG. 2 is a flow diagram illustrating call handling in one embodiment.

FIGS. 3 through 12 are display screens showing a user interface for a call and contact management system under one embodiment of the invention. FIG. 3 is a display screen showing a suitable login display under this embodiment of the invention. FIG. 4 is a display screen showing a suitable display for message notification and call routing options. FIG. 5 is a display screen showing a suitable display for providing call monitoring. FIG. 6 is a display screen showing a suitable display of electronic messaging features with attendants. FIG. 7 is an enlarged display screen showing a new icon in the system tray of the task bar in the Microsoft Windows operating system. FIG. 8 is a display screen showing a suitable display for configuring general setup options. FIG. 9 is a display screen showing a suitable display for configuring notification options in a setup mode. FIG. 10 is a display screen showing a suitable display for configuring advanced options. FIG. 11 is a display screen showing a suitable display for adding or modifying attendant options. FIG. 12 is a display screen showing a suitable display for adding or modifying monitoring options.

FIG. 13 is a display screen showing a suitable appointment dialogue box under Microsoft Outlook, with new fields for routing calls under one alternative embodiment.

FIGS. 14 through 27 are display screens showing a user interface for a standard call and contact management system under another alternative embodiment of the invention. FIG. 14 is a contacts management system display screen showing configuration options under this alternative embodiment. FIG. 15 is a contacts management system display screen showing account options. FIG. 16 is a contacts management system display screen showing notification options. FIG. 17 is a contacts management system display screen showing notification sound options. FIG. 18 is a contacts management system display screen showing connection options. FIG. 19 is a contacts management system display screen showing call handling code options. FIG. 20 is a contacts management system display screen showing attendant options. FIG. 21 is a contacts management system display screen showing an active call handling option pull-down menu. FIG. 22 is a contacts management system display screen showing a pull-down menu for accessing a web site. FIG. 23 is a contacts management system display screen showing a call history. FIG. 24 is a contacts management system display screen showing current user status options. FIG. 25 is a contacts management system display screen showing a current incoming call screen. FIG. 26 is a contacts management system display screen showing call transfer options. FIG. 27 is a contacts management system display screen showing call transfer options and contact information.

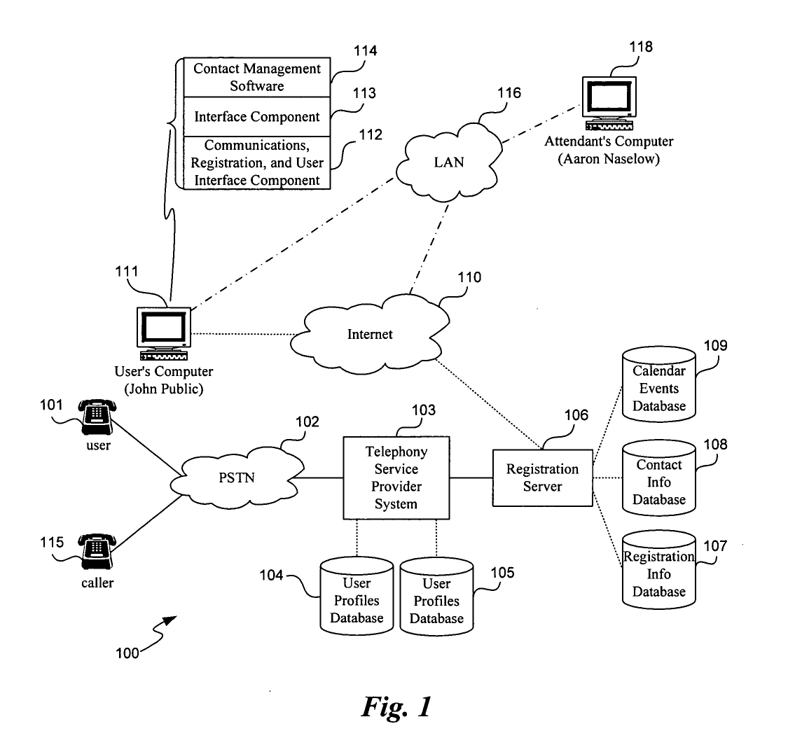

In the drawings, identical reference numbers identify identical or substantially similar elements or steps. To easily identify the discussion of any particular element or step, the most significant digit or digits in a reference number refer to the figure number in which that element is first introduced (e.g., block 103 is first introduced and discussed with respect to FIG. 1).

### DETAILED DESCRIPTION

A system for managing communications, described herein, is applicable to various types of communications, such as voice calls, emails and faxes. Embodiments include a method and apparatus for handling voice calls to multiple phone numbers through a single user interface. The user interface also allows access to the user's faxes and emails, and to the user's communication history and contact information. In one embodiment, the user is notified of any voice calls to one of several user devices. The user configures the system to handle incoming calls according to a user-defined configuration. For example, the system is configurable to route calls to various destinations, to access a history of previous communications with a caller, and to log or file the current call in the history. The call is handled based upon a code stored with a unique call source number in a standard contacts management system.

In the following description, numerous specific details are provided, such as specific steps, ordering of steps, user interfaces, and the like, to provide a thorough understanding of, and enabling description for, embodiments of the invention. One skilled in the relevant art, however, will recognize that the invention can be practiced without one or more of the specific details, or with other steps, ordering of steps, interfaces and the like. In other instances, well-known structures or operations are not shown, or are not described in detail, to avoid obscuring aspects of the invention.

Referring to FIG. 1, an example of a system 100 is shown in which an embodiment of the voice and data management system may operate. A user's telephone 101 is coupled to the public switched telephone network (PSTN) 102. Also connected to the PSTN 102 is a Telephony Service Provider System (“TSPS”) 103, which may include a telephone switching system for receiving calls from the PSTN, and a voice response system for providing various telephony services such as call forwarding, voice messaging, etc., as described herein. A user profiles database 104 is coupled to the Telephony Services Provider System 102, and provides information about the users of the system, and the various services and features provisioned for each user. Also coupled to the Telephony Service provider System 103 is a messages database 105, which contains voice and fax messages for the users of the system.

A registration server 106 is coupled (e.g., via a LAN, WAN, etc.) to the TSPS 102. The registration server 106 may be coupled to a registration information database 107, a contact information database 108, and/or a calendar event database 109. Further information regarding the registration server is provided below.

The registration server 106 is also coupled to a user's computer 111 via a network such as the Internet 110. The user's computer 111 is running various software components, including a communications, registration, and user-interface component 112, an interface component 113, and a contact management software component 114 (described below).

Under one embodiment, the TSPS 103 provides numerous call handling options to users, such as call screening services, the ability to redirect or re-route received calls to another phone location on the PSTN 102, etc. For example, if a caller associated with a caller telephone 115 (which is coupled to the PSTN 102) dials a telephone number associated with the user, that telephone number may be routed by the PSTN to the TSPS 103. (As described herein, such telephones may be any telecommunications devices, including devices configured to handle voice calls.) The TSPS 103 will then consult the user profile database 104 to determine the call handling method that should be used to handle that call. In one example of a call handling method, the call may be routed to a voice mail subsystem of TSPS 103, causing a message to be left in the messages database 105. In another example of a call handling method, the user profile database may contain a forwarding number for the user, and the TSPS 103 may reroute the incoming call through the telephony switch contained within 103, out through the PSTN 102 to the user's phone 101.

Note that the TSPS may also contain a voice response system that, depending on the call handling method selected, may provide various prompts associated with each call handling method. A user may have many pre-defined call handling methods stored in the user profiles database, and may select the call handling method to be used at any moment in time, by selecting for example a numeric code which is associated with that call handling method. Thus, the user may alter or change predefined call handling methods using any known user interface, such as via the user's telephone (landline or mobile phone) using DTMF or speech-recognition, via computer network such as a web interface coupling the user's computer 111 with the registration server 106, via a wireless portable palm top or wearable computer, via a wireless pager, via set-top box or other consumer premises equipment, or any other equipment.

Under one embodiment, the user computer 111 provides the user with access to real-time voice calls and to many voice call management functions, as described herein. The user computer 111 includes contact management software 114, such as an available, off-the-shelf contact management software package or system such as Outlook™ or Lotus Notes™ (although a custom configured contact management system can be partially or entirely employed). An interface component 113 is a software application that communicates with the contact management software 114, a communications, registration, and user interface component 112, and a registration server 106 (described below). The interface component 113 interfaces with the contact management software 114 using open application program interfaces (APIs) published by the manufacturer of the contact management software to permit other software components to interface and exchange data with the contact management software.

In one embodiment, the interface component 113 and the communications, registration, and user interface component 112 enhance the functionality of a telephony service provider system (TSPS) 103 and the registration server 106. Interface Component 113 provides an interface to the standard APIs presented by the Contact Management Software 114. For example, in an embodiment intended for Outlook™, interface component 113 may be a dynamic link library, or “DLL”, which implements the Microsoft “IDTExtensibility2” library for Outlook™, which can be used to provide access to the Microsoft “Outlook™ Object Model”. The Outlook™ Object Model provides methods and properties that allow a program to read and manipulate data in Outlook™, and to manipulate the Outlook™ user interface.

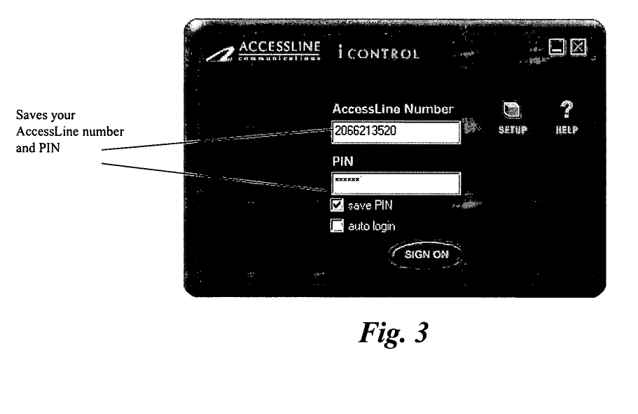

The communications, registration, and user interface component 112 may be implemented using a variety of methods. For example, under the embodiment that is further described with reference to FIGS. 3-13, component 112 is implemented as two applications, each performing a specific set of functions. First, a stand-alone Java application is used to implement the graphical user interface functions, and the functions of communicating with the registration server 106. This communication is implemented within the Java application as a series of extensible markup language (“XML”) messages over transmission control protocol over Internet protocol (“TCP/IP”). A second stand-alone application is implemented as a background executable with no user interface. This executable uses the Microsoft Component Object Model, or “COM”, to communicate with the Java application on one side, and the DLL of the interface component 113 on the other side.

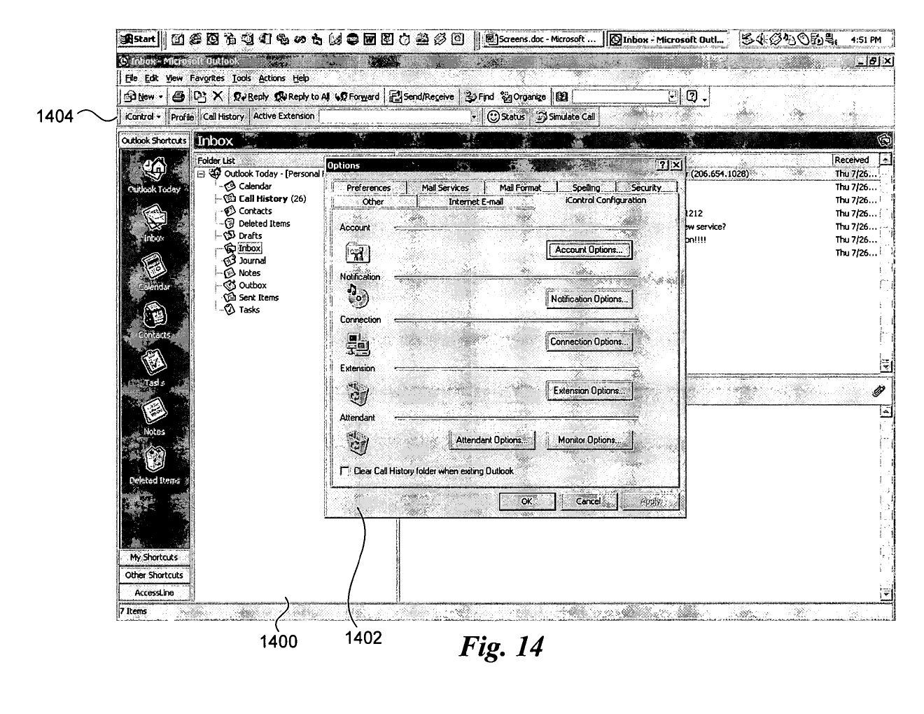

Under the described embodiment with reference to FIGS. 14-27, component 112 is implemented using two components. The first component, an “OCX” component, implements the user interface functions, including the manipulation of the Outlook™ user interface, for example the manipulation of properties pages within Outlook™. OCX is a specific type of DLL defined by Microsoft. The OCX uses Microsoft COM to communicate with a DLL of the interface component 113, which in turn accesses the Outlook™ Object Model as described above. The second component is a DLL that handles the communication with the registration server 106, using XML messages over TCP/IP. This DLL uses COM to communicate with the OCX, and also uses COM to communicate with the interface component 113.

As noted above, the TSPS 103, in one embodiment, includes a one-number system that allows a user to give one number to callers that wish to call various devices and send faxes. An example of a telephony service provider system is described in U.S. Pat. No. 5,752,191, entitled “Telephone Control System Which Connects a Caller With a Subscriber at a Telephone Address,” U.S. Pat. No. 5,610,970, entitled “Telephone System With Scheduled Handling of Calls,” U.S. Pat. No. 5,673,299, entitled “Adjunct Controller for a Telephone System” and U.S. patent application Ser. No. 60/223,160, titled System and Method for Universal Access of Messages, such as Voice Mail Messages, filed Aug. 7, 2001.

The user computer 111 communicates with one or more other computers, such as an attendant computer 118, through a network, such as a local area network (LAN) 116. In one embodiment, the attendant computer 118 is a computer used by anyone to whom the user may want to refer certain communications, including voice calls, that are sent to the user (e.g., a secretarial computer).

The TSPS 103 includes software and hardware that communicates with the public switched telephone network (PSTN) 102 to receive voice calls made through the PSTN and manage calls, via the user computer 111, according to the user's wishes. The user may subscribe to the services provided by the TSPS, which the user may access via the user phone 101. The user may also access features of the TSPS via the user computer 111 and the registration server 106.

The registration server 106 transmits data between the user computer 111 (including the interface component 113, the communications, registration, and user interface component 112), the TSPS 103, and the various databaseS 107, 108, and 109. The registration information database 107 stores information about the user, including a current user status. The current user status includes a location of the user (e.g., a network computer the user is currently logged onto) and whether the user is available to answer certain calls. For example, if the user has used her computer 111 to log onto the internet 110, then the communications, registration, and user interface component 112 may send a message via the Internet 110 to the registration server 106 indicating that the user is available and on-line. The registration server 106 will store this information in registration information database 107. This database contains the user's current TCP/IP address on the Internet 110, along with any data or indication that the user may have passed via the user interface component 112 indicating the user's desire for handling of calls (as described below). Under one embodiment, this information may be used to provide a real-time indication to the user via the computer 111 of an incoming call, including the identity of the incoming caller. This information may also be used to modify the call handling of the system, for example, to override or modify the screening instructions provided by the contact info database 108. In one embodiment, the registration information database 107 further stores an identity and location of an attendant to which certain calls are to be forwarded. The communications, registration and user interface component 112 includes a the user interface process which provides a graphical user interface as described in FIGS. 3-12, or alternatively in FIGS. 14-27. The component 112 further includes a registration process that registers with the registration server 106 when the user logs on via the user interface, and a communications process that is responsible for handling messages sent between the registration server and the user's computer. The interface component 113 includes a software process that acts as a communications interface between the component 112 and the contact management software 114 by invoking the APIs of the contact management software, such as the Outlook™ API, for example to query the contact management software 114's databases and/or to manipulate its user interface.

The contacts information database 108 stores information about the user's contacts. In one embodiment, the contact information is loaded into the database 108 from the contact management system 114, either automatically at intervals, or in response to a user command. The calendar events database 109 stores information about the user's calendar, and the source of calendar information is the contacts management software 114. Thus, the calendar events database 109 may be used to store information regarding the meetings and activities stored in the calendar of the user's contact management software 114. This information is then retrieved from the contacts management software 114 and stored in the calendar events database 109 in the same manner as the contact information database 108 retrieved its data, as described herein. Information in the calendar events database 109 is used to handle calls. For example, all calls or calls from particular callers may be handled differently on different days, or when certain types of meetings are in progress. Alternatively, the information may be used to modify the call handling instructions based on the type of meeting currently in progress, or based upon other attributes associated with the meeting.

In another alternative embodiment, the TSPS 103, the registration server 106, and databaseS 104, 105, and 107-109 are integrated into a single server computer. Thus, the TSPS 103 and registration server 106, and databaseS 104, 105, and 107-109 shown in FIG. 1 represent logical connections in this alternative embodiment. Although not required, aspects of the invention will be described herein in the general context of computer-executable instructions, such as routines executed by a general-purpose computer, e.g., a server or personal computer. Those skilled in the relevant art will appreciate that these aspects of the invention can be practiced with other computer system configurations, including Internet appliances, hand-held devices, wearable computers, cellular or mobile phones, multi-processor systems, microprocessor-based or programmable consumer electronics, set-top boxes (such as for use with cable TV), network PCs, mini-computers, mainframe computers, and the like. The invention can be embodied in a special purpose computer or data processor specifically programmed, configured or constructed to perform one or more of the computer-executable instructions explained in detail below. Indeed, the term “computer,” as generally used herein, refers to any of the above devices, as well as any data processor.

While not shown, the computers described herein, including the server 106, TSPS 103 and computer 111, include one or more central processing units or other logical processing circuitry, memory, input devices (e.g., keyboards and pointing devices), output devices (e.g., display devices and printers), and storage devices (e.g., fixed and floppy magnetic disk drives, optical disk drives and card readers), all well known, but not shown. While shown as separate components, databases, such as the database 106, may form part of, or be integrated with, the server computer. The computers may include other program modules not described herein, such as an operating system, one or more application programs (e.g., word processing or spreadsheet applications), a web browser, and the like. Unless described otherwise, the construction and operation of the various blocks shown in the figures are of conventional design. As a result, such blocks need not be described in further detail herein, as they will be readily understood by those skilled in the relevant art.

The invention can also be practiced in distributed computing environments, where tasks or modules are performed by remote processing devices, which are linked through a communications network. In a distributed computing environment, program modules or subroutines may be located in both local and remote memory storage devices. Aspects of the invention described herein may be stored or distributed on computer-readable media, including magnetic and optically readable and removable computer disks, hard-wired or preprogrammed in chips (e.g., EEPROM semiconductor chips), as well as distributed electronically over the Internet or via other networks (including wireless networks). Processes or software components under aspects of the invention may be created under various ways, such as through source code programming, created as microcode or programmed logic arrays, or the like. Those skilled in the relevant art will recognize that portions of the invention reside on a server computer, while corresponding portions may reside on a client computer (such as the user computer 111). Data structures and transmission of data particular to aspects of the invention are also encompassed within the scope of the invention.

Embodiments described herein include the TSPS 103 interfacing with the contact management software 114 through the interface component 113 to provide call handling to the user through the single user interface 112. In one embodiment, the user populates a database associated with the contact management software 114 with contact information. The contact information includes names, addresses, email addresses, phone number, etc. such as the user's contact's name, home and business telephone number, and email address. According to an embodiment, an unused portion of a data field in the contact management software 114 database is populated with a handling code. The handling code is innocuous in the contact management software 114 environment. In one embodiment, a two digit handling code is placed in an unused portion of the phone number field. The handling code is one of a group of codes that each refers to a particular handling method. Handling methods include forwarding a call to another number, notifying the user the call has been received, forwarding the call to voicemail, forwarding the call to a Internet chat session between the user and the caller, sending an instant message, and playing various messages to the caller such as an “unavailable” message, an “out of town” message, a “touch 0” message, many various prompts, etc.

The user associates the handling codes with the handling methods in the TSPS as part of configuration of the TSPS. Thus the user may enter the desired two digit code for selected contacts in the contact management software 114. A user may have many pre-defined call handling methods stored in the user profiles database 104, and may select the call handling method to be used at any time, by selecting for example a numeric code which is associated with that call handling method. Thus, the user may alter or change predefined call handling methods using any known user interface, such as via the user's telephone (landline or mobile phone), via computer network such as a web interface coupling the user's computer with the registration server 106, via a wireless portable palm top or wearable computer, via a wireless pager, via set-top box or other consumer premises equipment, or any other equipment.

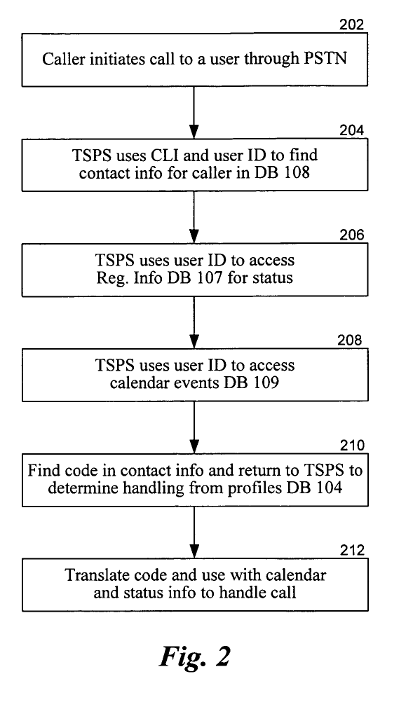

The interface component 113, residing on the user's computer 111, will either periodically, or manually as directed by the user via the interface component 112, read the contact information employing well known and published API interfaces to the contact management software's database. This software will then pass the specific numeric code associated with each contact to the communications software component 112, which in turn will pass this data through the Internet 110 to the registration server 106, which will again in turn pass this data to the contact information database 108 for storage. FIG. 2 is a flow diagram illustrating the operation of an embodiment of the voice data management system 100. Unless described otherwise herein, the blocks depicted in FIG. 2 are well known or described in detail in the above cross-referenced provisional patent application. Indeed, much of the detailed description provided herein is explicitly disclosed in the provisional patent application; much of the additional material of aspects of the invention will be recognized by those skilled in the relevant art as being inherent in the detailed description provided in such provisional patent application, or well known to those skilled in the relevant art. Those skilled in the relevant art can implement aspects of the invention based on the flowchart of FIG. 2 and the detailed description provided in the provisional patent application.

At block 202, a caller places a call from the phone 115 to the user. The call can be placed to the user's phone 101, or to another user device, such as a cell phone or fax machine. A call placed to any user device that is recognized by the TSPS 103 and associated with the user will be handled according to the embodiment. The TSPS 103 includes a telephony switch for receiving telephone calls from the PSTN 102. The telephony switch may also redirect or re-route those received calls anywhere on the PSTN 102. The incoming call may have a calling line identification (CLI) number or similar identifying data associated with it, where the number is typically the phone number of the calling device (the phone 115). The CLI is a unique identifier for the calling device. Because one person typically uses devices, the CLI usually identifies the caller.

As shown at block 204, the TSPS 103 then instructs the registration server 106 to search the contact information database 108 using the CLI and the user phone number (dialed in digits) to find the handling code associated with the CLI. Alternatively, the registration server identifies and retrieves the user's account using other received information in the call, such as a direct inward dialing (DID) number, dialed number identification service (DNIS) data, or a automatic number identification (ANI) number. At block 206, the registration server 106 finds the current user status in the registration information database 107. At block 208, the registration server 106 searches the calendar events database 109 for any relevant calendar information. At 210, registration server 106 searches the user profile database 104 to find the handling method associated with the handling code. At 212, the TSPS translates the handling code and uses all of the associated information to handle the call.

The flow shown in FIG. 2 illustrates the gathering of previously configured user information that is used by the TSPS to handle the call. The ordering of the flow diagram is for illustration and is not exclusive of any other orderings. It is not practical to list all of the call handling permutations available to the user in configuring the TSPS. For various calls, different elements of the previously configured information are needed to determine call handling. For example, the TSPS may determine how to handle some calls immediately after finding the status information. For other calls, the TSPS may need the calendar information, the status information, and the handling code.

Applying an example to the method of FIG. 2 and the system of FIG. 1, a caller places a call, via the phone 115, to a phone number hosted by the TSPS and associated with the user. The called number (e.g. for the phone 101) is routed via the PSTN 102 to the TSPS 103. The incoming call has a calling line identification (CLI) number associated with it, which indicates the phone number of the calling party. The TSPS 103 then looks at information in the user profile database 104 and determines that the user wishes to have her calls routed according to the screening information from her contact list. The TSPS then contacts the registration server 106, which in turn queries the contact information database 108 using the CLI and the called number as keys. In this example, the database contains a contact for this user with a number that matches the CLI, and thus the database query will return the numeric code to be used for screening this incoming call. The registration server 106 passes this numeric code back to the TSPS 102. The TSPS then uses that numeric code as a key to retrieve the associated call handling method to be used for this call. If, by way of example, the call handling method indicates that the call should be forwarded to the user's current phone number, then the TSPS 102 will reroute the call using its internal telephony switch via the PSTN 102 to the user's phone 101. In another embodiment, the TSPS 102 may use call transfer or similar features of the PSTN to perform this call forwarding, eliminating the need for a switching function within the TSPS 102.

Under one embodiment of the invention, the user may configure and use the TSPS 103 through the user interface of the component 112. One embodiment of this user interface will be described with reference to FIGS. 3-13. The user interface of FIGS. 3-13 is part of a communication management system as described with reference to FIGS. 1 and 2, including client software that provides desktop management and control of incoming calls and messages. Such software (designated as “iControl” in FIGS. 3-6) provides an Internet or web-based conduit between a user's existing contact and calendar management software (such as Microsoft Outlook or Lotus Notes) and the user's telecommunications service provider, such as a one-number system (or TSPS number). The system provides real time call control, for example with pop-up dialogue boxes on the user computer 111. The user also receives real time message notification. Call control can also be distributed across a community of users, as illustrated by the communication between the user computer 111 and the attendant computer 118. Thus, this embodiment permits call control to be distributed between two or more computers connected via a local area or wide area network (such as between a user and her secretary, receptionist and/or administrative assistant).

Referring to FIG. 3, an example of a login screen is shown, where the user enters his or her assigned TSPS telephone number and associated personal identification number (PIN). The user may also select a box to save the PIN number, and/or a box to automatically log the user in to the registration server 106 (via the Internet 110), when booting up the user computer 111.

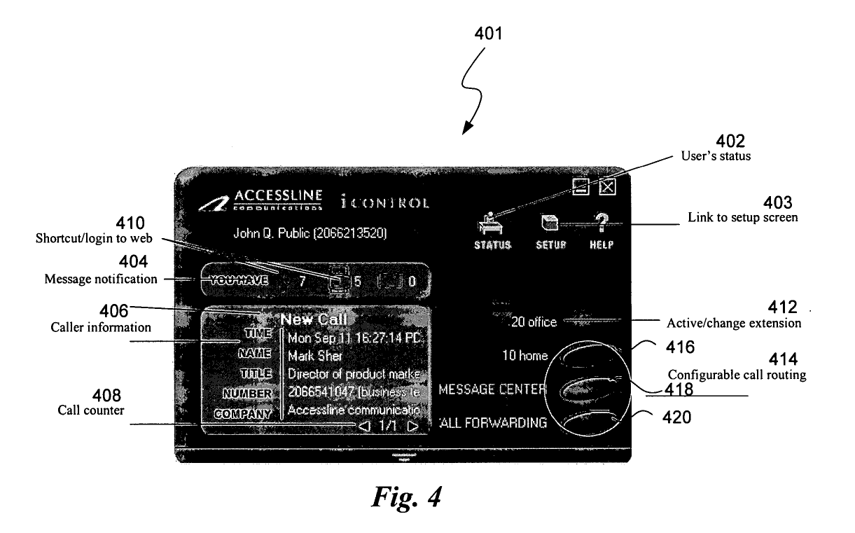

Referring to FIG. 4, a suitable display screen 401 for displaying user control of incoming calls on the user computer 111 is shown. A user status button 402, setup screen button 403, and help button are clicked to display status, setup and help screens, respectively. By selecting the user status button 402 a user may indicate his or her status as either available or unavailable to receive calls. A message notification portion 404, caller information portion 406, and other controls shown in the screen of FIG. 4 are also displayed to the user. The message notification portion includes voice mail, fax mail, and email icons with associated numbers indicating the number of messages received. In the example shown in FIG. 4, the user, “John Q. Public” has seven voice messages and five fax messages, but zero email messages. Clicking on the icon 410 in the message notification portion 404 causes the user computer to automatically display appropriate graphical user interface (GUI) controls for accessing voice mail, fax mail, or email via associated applications.

The caller information portion 406 displays information regarding a newly received call, including the time, name of the incoming caller (based on a name associated with the CLI), title of the person, the incoming number, and the caller's associated company. The caller information portion also includes a call counter 408 that identifies a number of calls received by the user since the user last accessed the system. In addition to voice messages, calls answered by the user and fax messages received for the user are also numbered. The call counter may be reset manually. The call counter may alternatively be reset each time the user accesses the screen 401, or according to some other reset criteria.

A lower right-hand portion of the screen 401 identifies call-handling options for the user. An active extension indicator 412 indicates how incoming calls are currently handled. For example, whenever anyone calls the user at the number indicated in the screen, which is 206-621-3520, the call is routed based on call handling code “20 office.” The user has previously defined that the call handling code 20 corresponds to forwarding calls received by the TSPS to the user's office phone. The user may define many differing call handling codes as previously described.

Three configurable call routing buttons 414 allow the user to route incoming calls in real-time. For example, the newly received caller information in window portion 406 describes an incoming call (that “Director of Product Marketing, Mark Sher” is calling). As the user views the information, the user can choose to have the incoming call automatically routed to a message center by selecting button 418. The user can also choose to forward the call, for example to an attendant, by selecting button 420. The user can also select button 416 to have the call forwarded to a home number based on a predefined call routing option defined by the user as “10 home.”

Many handling alternatives are available for incoming calls. For example, the user may right-click a mouse button on any of the buttons 416-420 to configure these buttons for different call handling options. Right-clicking on one of these buttons displays a dialogue box (not shown) that allows the user to select among several predefined options to be assigned to numerical codes and GUI buttons 416-420. In one embodiment, selecting the call forwarding button 420 causes a menu of predefined and configurable call handling options to be displayed to the user so that the user can dynamically route calls to a much larger number of destinations than are represented by the buttons shown in FIG. 4.

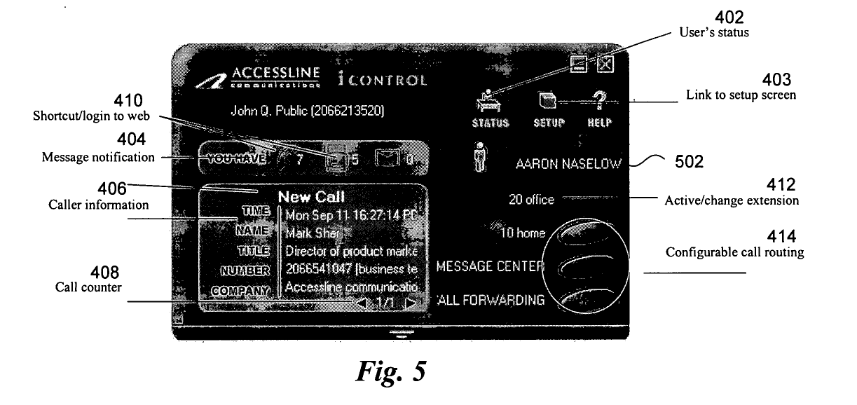

Referring to FIG. 5, the user can designated an attendant who also may control routing of the user's calls. As indicated by the icon and name portion 502, the user has designated Aaron Naselow as having permission to handle the user's calls. Aaron Naselow may monitor incoming user calls and handle such calls with the same ability as the user. Consequently, call control is distributed across a community of users.

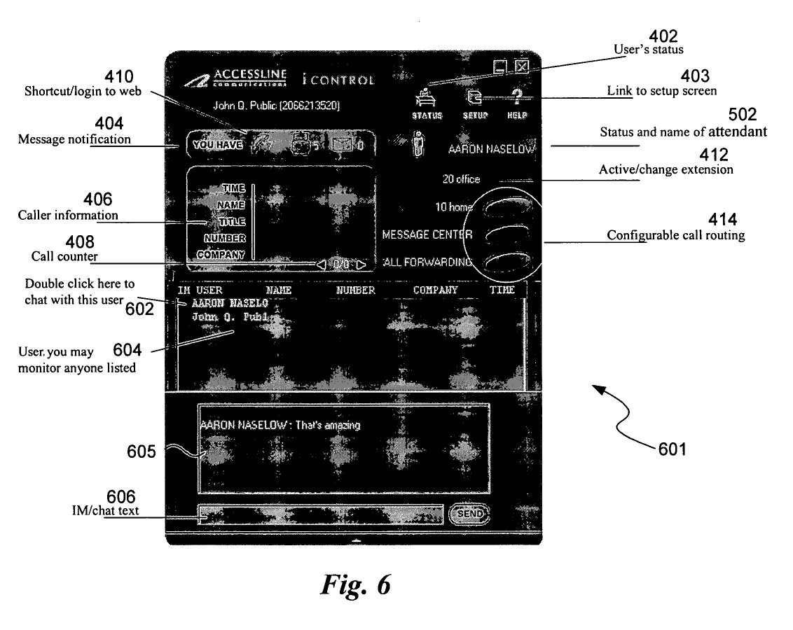

Referring to FIG. 6, a messaging screen 601 is shown that permits the user and one or more user-designated attendants to communicate via electronic messaging (similar to chat room communication). A portion 604 lists all other computer users the user may monitor and with whom the user may communicate. Clicking on one of the listed users, such as an “Aaron Naselow” listing 602, causes a message exchange window 605 to display a running text dialogue between the user and the other selected user. As shown in FIG. 1, the user computer 111 may then communicate with the other selected computer, such as the attendant computer 118 via appropriate connections, such as a local area network 116. The system may be configured to exchange messages via any known communication method, such as via the Internet or via wireless devices. The user enters text to send to the selected person in a text entry box 606. Such messaging may be performed using other messaging protocols, such as Short Messaging Service (“SMS”), instant messaging, etc.

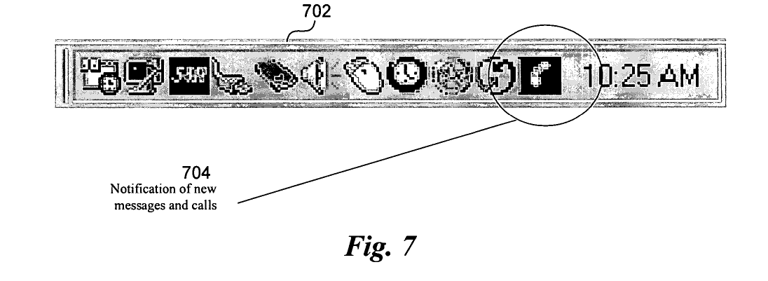

Referring to FIG. 7, an example of a system tray 702 in the Windows™ operating system is shown with an icon 704 that identifies to the user that new messages or calls have been received. Thus, a call processing agent under this embodiment runs continuously within the Windows™ operating system and provides an appropriate notification (through existing Windows™ APIs) to the user that incoming calls or messages have been received, as described more thoroughly herein.

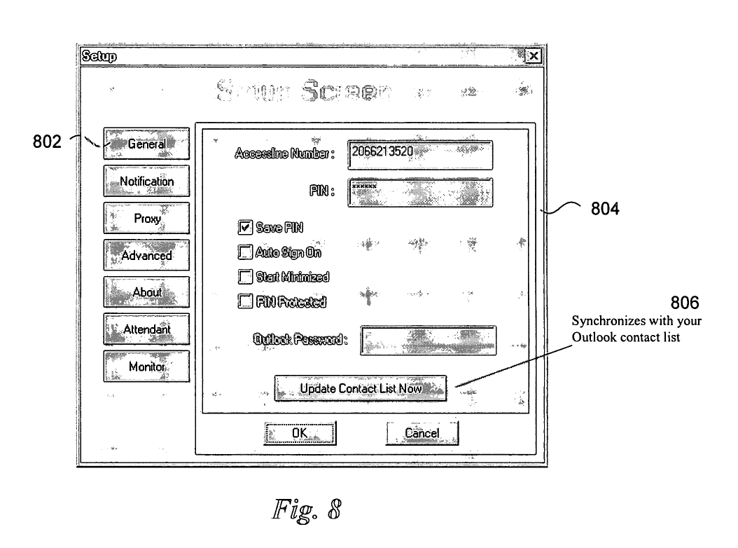

The user configures the system using setup screens that are displayed by clicking the setup screen button 403. Setup will now be described with respect to FIGS. 8-12. Referring to FIG. 8, when the user selects a “General” button 802, a general setup screen 804 is displayed to the user. The general setup screen allows the user to enter the user's telephone number and PIN, as well as select several options, such as saving the PIN, automatically signing on, starting the software application with display screens minimized, and protecting the PIN (such as using encryption or other known protection methods). Also displayed in the general startup screen is a text entry box in which the user enters a password for accessing the user's contact management system. Examples of contact management systems are Microsoft Outlook™ and Lotus Notes™. Clicking an “Update Contact List Now” button 806 updates the user's contacts in the contact information database 108 to correspond to the latest information in the contact management software database 114.

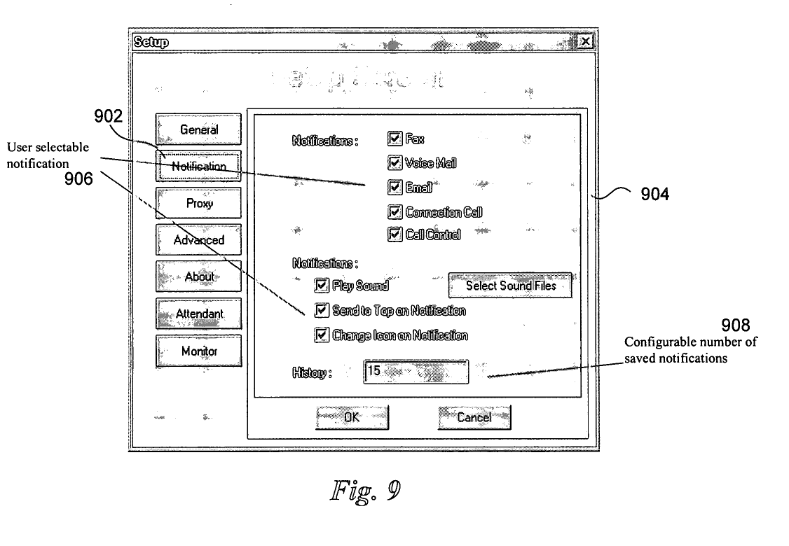

Referring to FIG. 9, a “Notification” button 902 causes a notification setup screen 904 to be displayed. The notification setup screen 904 permits the user to select various notification options 906. Notification options include whether the user wishes to be notified when he or she receives new faxes, voicemail, email, one-number connection calls, or all generally received incoming calls (“call control”). Notifications may include playing a sound to the user over the user's computer, popping an active screen that provides information regarding the call (such as the screen 401 of FIG. 4), or changing the icon (for example, changing the pointer momentarily to a telephone icon when an incoming call is being received). The user configures the number of notifications saved by the system in a box 908.

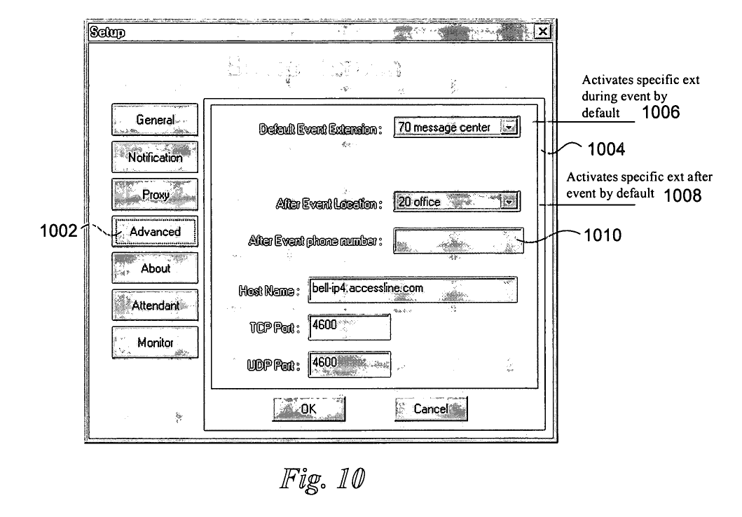

Referring to FIG. 10, an “Advanced” button 902, causes an advanced setup screen 1004 to be displayed. A default event extension box 1006 displays a list of all predefined call routing codes or extensions predefined by the user (such as “20 office,” “10 home,” and “70 message center”). In the example of FIG. 10, during an event or appointment scheduled on the user's calendar (through the contact management software), calls are routed by default to the message center under call routing option 70. Of course, certain calls may be predefined, as noted herein, to be routed directly to the user at a phone associated with the event (such as calls from the user's superiors routed automatically to an extension of a phone in a conference room for the event). An “After Event Location” box 1008 allows the user to select any predefined call routing codes, from a drop-down menu, and to enter any associated numbers in a box 1010. In the example of FIG. 10, after any calendared events, calls are routed by default according to the predefined call routing option “20 office,” which may route calls to the user's office phone. One or more of the call handling codes may not have a phone number associated with it, and thus the user may be required to enter a number in the after-event phone number box 1010 (as described below).

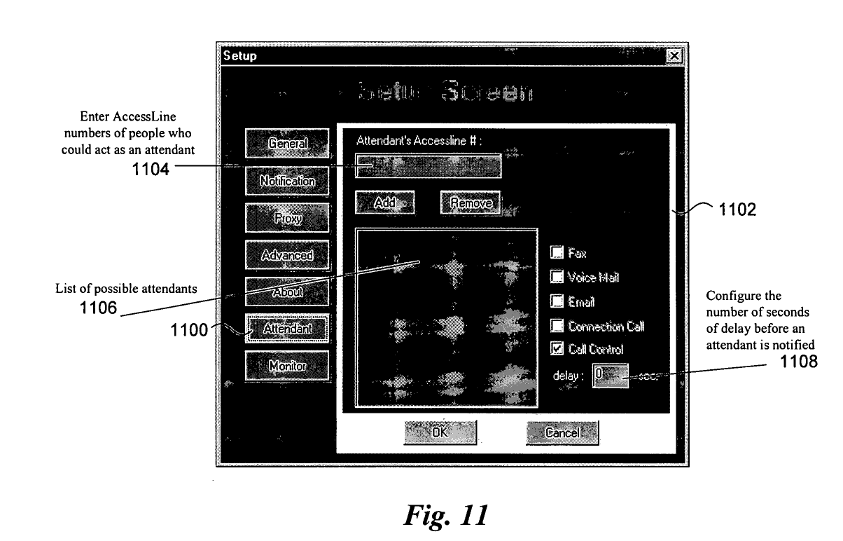

Referring to FIG. 11, an “Attendant” button 1100 causes a setup attendant screen 1102 to be displayed. In screen 1102, the user may enter attendant telephone numbers in a box 1104. In a portion 1106, the user lists names of one or more attendants, and with each attendant, selects access options for that attendant, such as whether the selected attendant may access and route the user's faxes, voicemail, email, connection calls, or all general calls. A delay box 1108 allows the user to select the number of seconds before the selected attendant is notified of an incoming call. For example, the user may wish to select a two-second delay that would allow the user to first determine how to handle an incoming call. After two seconds the system automatically routes the call to the selected attendant.

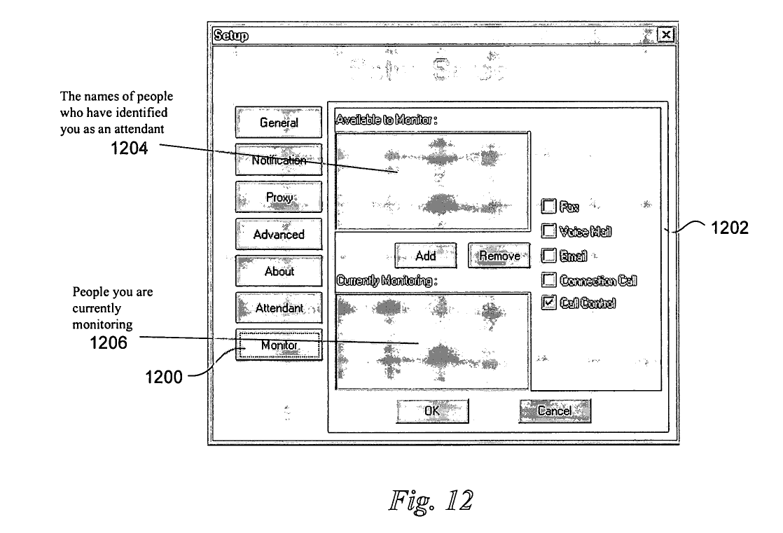

Referring to FIG. 12, a “Monitor” button 1200 causes a setup monitor screen 1202 to be displayed. A list of other computer users the user is able to monitor appears in a portion 1204. A list of other computer users currently monitored appears in a portion 1206. Thus, the user may act as an attendant for others, to thereby monitor and handle other users' calls. Attendants and users being monitored do not need to be computer users, and do not need to be coupled directly to the computer of another.

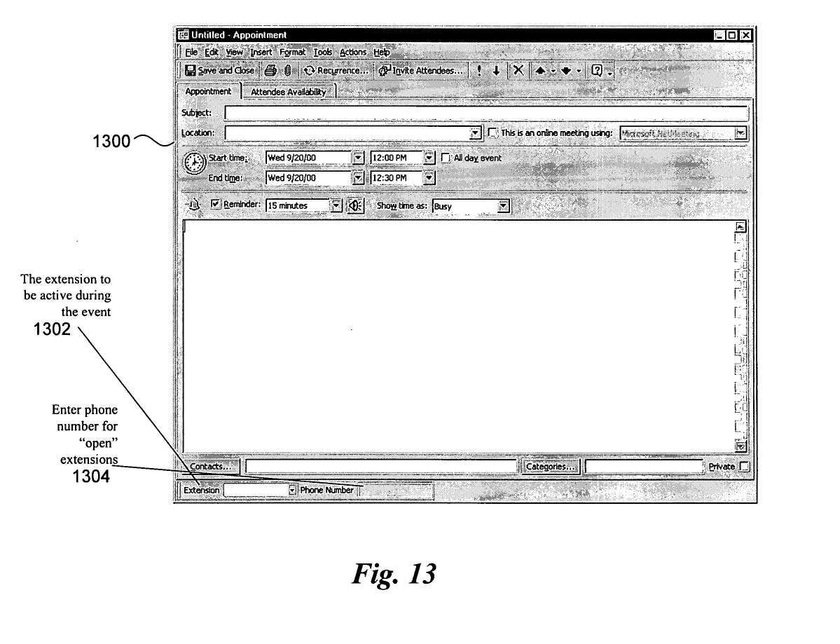

FIG. 13 shows a new appointment screen 1300 generated by a calendaring aspect of the Microsoft Outlook™ contact management software. Much of the screen 1300 is standard under the Outlook™ software application. However, as shown in FIG. 13, the screen 1300 also includes an extension field 1302 and phone number field 1304. The extension field allows the user to associate a call handling code (such as “20 office,” “10 home,” and the like as discussed above) with respect to an appointment scheduled by the user. Thus, during the scheduled appointment, calls to the user are handled according to the associated call handling code previously established by the user.

One or more call handling codes may not have associated phone numbers. For example, the user may have predefined an “80 hotel” code that defines how calls are to be handled when the user is at a hotel room. In this situation, the user may then enter a phone number in the phone number field 1304 associated with a particular hotel at which the user will be staying. The phone number may be entered before the user travels to the hotel, or the user may enter the phone number while at the hotel, by logging in to the registration server 106 via the Internet 110, and uploading this number for storage in the calendar events database 109.

Traditional communication management systems provide for management of one type of communication on one type of platform. For example, while a voice mail system allows user management of voice mail messages, an electronic contact management system such as Microsoft Outlook™ or Lotus Notes™ allows management of email destined for one email address. An electronic contact management system further provides a configurable user database that stores extensive contact information and history information related to past communications. A cellular phone message service, on the other hand, allows management of all voice calls placed to a particular cellular phone or forwarded to the particular cellular phone. Existing systems do not provide access to communication management capability across devices while simultaneously providing access to contact information and communication history information.

In another alternative embodiment, the above functionality is provided to such existing communication management systems. In this alternative embodiment, the user configures and uses the TSPS 103 through the user interface of the contact management software 114, where the contact management software is a standard, off-the-shelf product (e.g. Lotus Notes™ or Microsoft Outlook™). This user interface will be described with reference to FIGS. 14-27. The contact management software 114 interfaces with the interface component 113 through open APIs. The contact management software 114 is configurable through its graphical user interface and through its APIs.

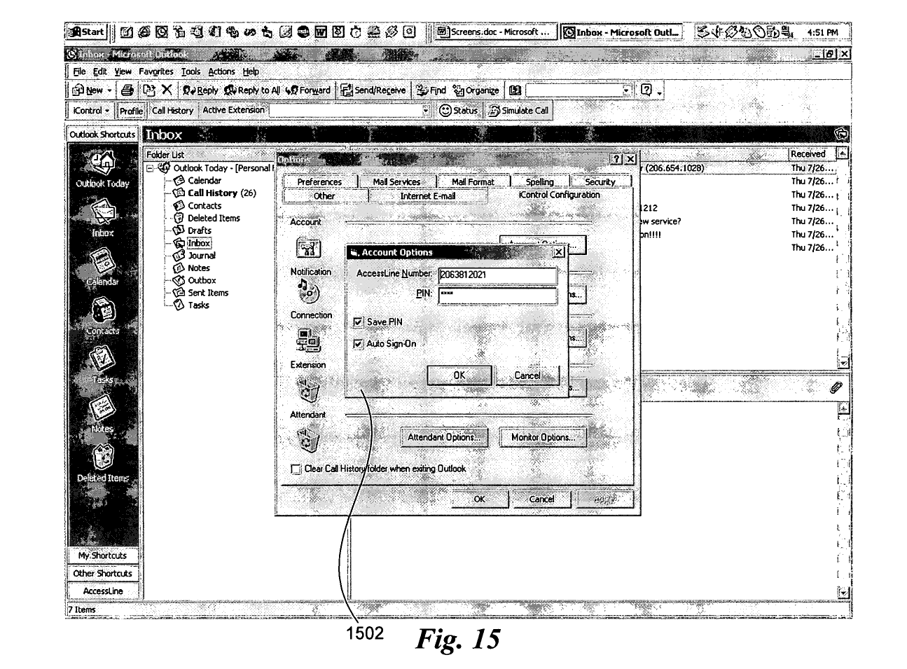

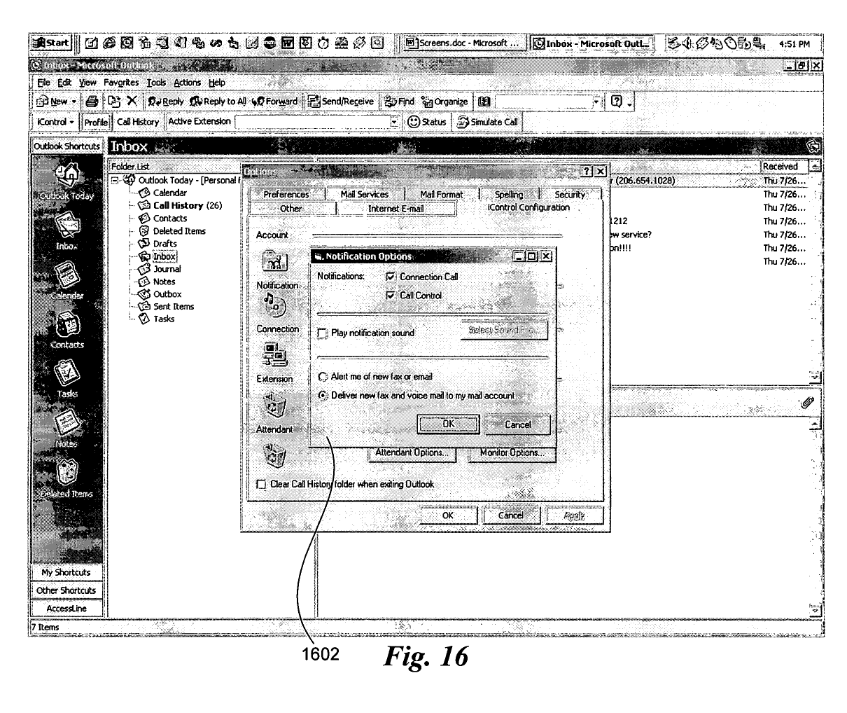

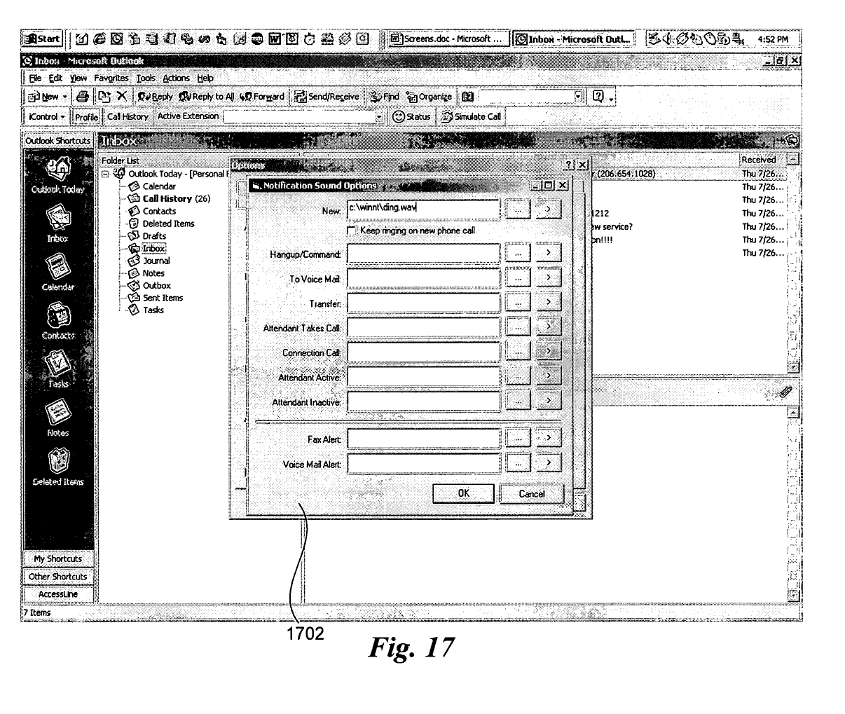

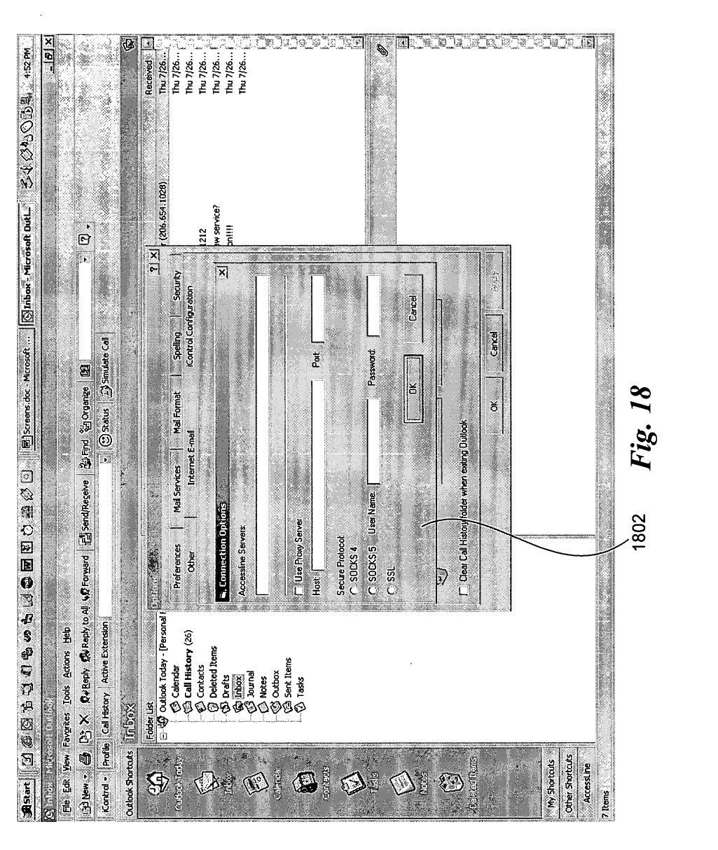

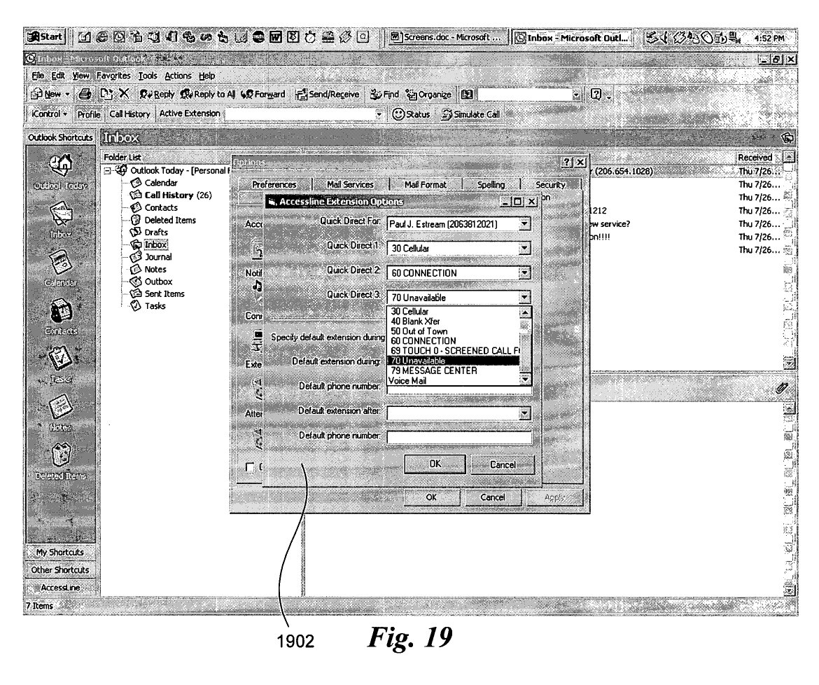

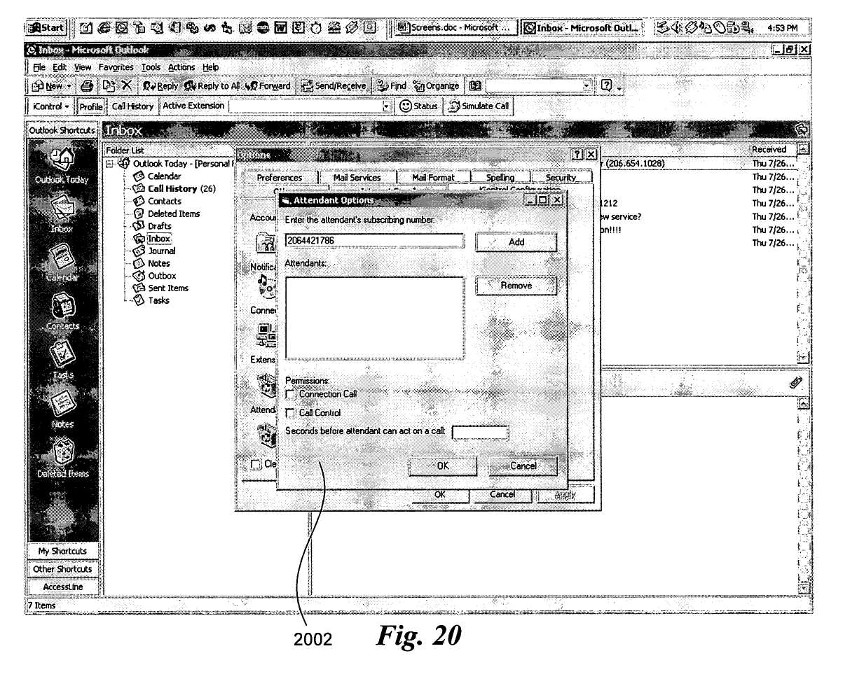

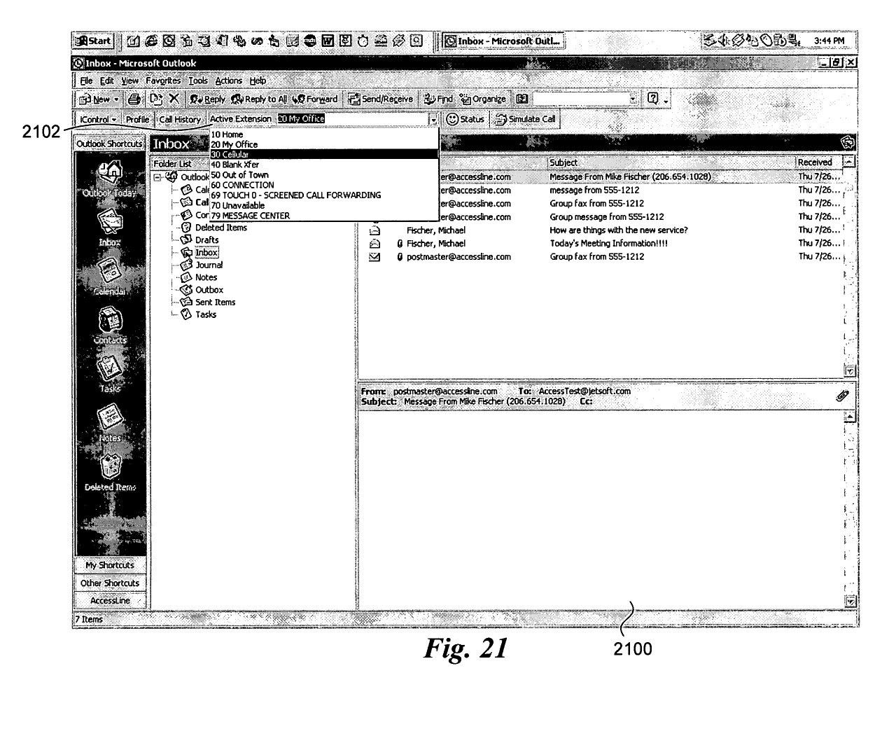

FIG. 14 shows a typical Microsoft Outlook™ inbox screen 1400. The tool bar 1404 however includes a button for “iControl”, which is an embodiment of a communication management system including a TSPS, as noted above. The iControl button and associates buttons are added to the Outlook™ user interface. “Profile”, “Call History”, and “Status” buttons to the right of the iControl button are each associated with call management and handling functions under this embodiment. By clicking the “Profile” button, an options screen 1402 is displayed that allows user configuration of iControl as shown and described herein. Specifically, the user may configure user account options (FIG. 15), notification options (FIGS. 16 and 17), connection options (FIG. 18), extension options (FIG. 19), attendant options (FIG. 20), and monitor options (FIG. 21) by selecting appropriate buttons shown on the options screen 1402 to display appropriate screens to configure such options.

In one embodiment, the communication management system includes a one-number system. FIG. 15 shows a user account options screen 1502 (similar to that in FIG. 8) that allows the user to enter a phone number for the one-number system, and a PIN for the system. The user can also cause the PIN to be saved and for sign-on to be automatic when the user logs on.

FIG. 16 shows a notification options screen 1602 for configuring user notification. In the screen 1602 the user has chosen connection call and call control (similar to those options described above with respect to FIG. 9). The user has also chosen to have new faxes and voice mail sent to a mail account, for example the Microsoft Outlook™ email inbox. The user may also cause the system to notify the user when a fax or email message is received.

FIG. 17 shows a notification sound options screen 1702 displayed to the user if the user selects a “Select Sound File” button associated with a “Play notification sound” option in screen 1602. Through the screen 1702, the user can designate a sound file to be played for different situations, such as “Hangup/Command”, “To Voice Mail”, and other call options depicted in screen 1702. The user can also choose sound options for fax alerts and voice mail alerts. A “ . . . ” button selects from various available sound files, and a “>” button allows the user to play the file to test it.

FIG. 18 shows a connection options screen 1802 (similar to screen 1004) for configuring connections, including specifying servers, ports, protocols, and other connection options shown.

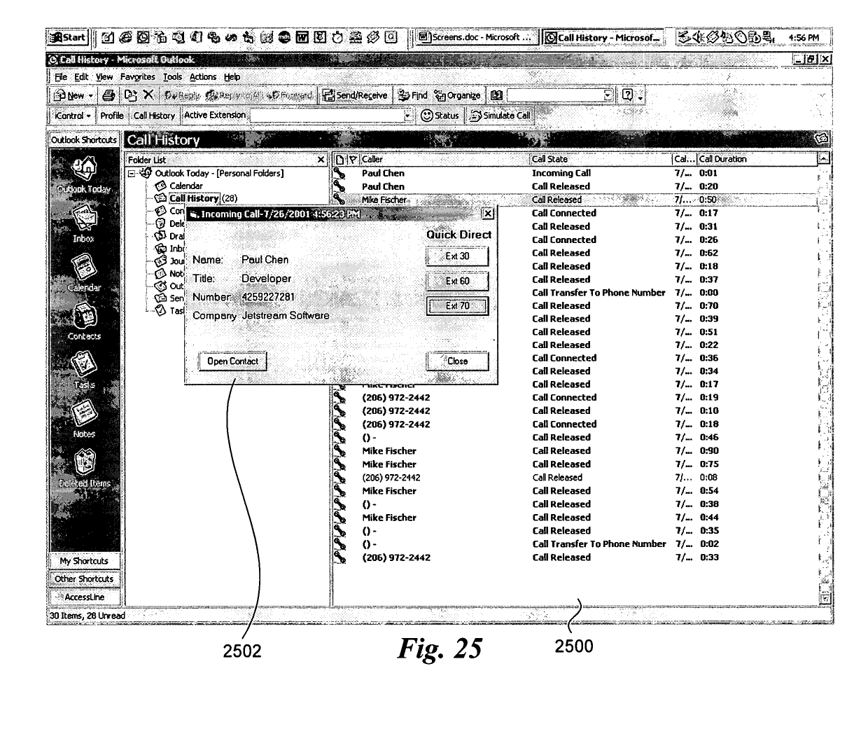

FIG. 19 shows an extensions options screen 1902 for configuring handling codes. Pull-down menus list codes to be associated with various “Quick Direct” numberS 1, 2, and 3 (shown below in FIG. 25). “30 Cellular” is currently chosen for number 1, “60 Connection” is currently chosen for number 2, and the pull-down menu choices are displayed for number 3. At the bottom half of screen 1902, the user may specify the default call handling codes, or extensions, to be used during an Outlook™ calendar event, such as a meeting. The user may specify the default extension, and optionally the phone number, to be used during a calendar event, and after a calendar event. Note that this is the default call handling method for a calendar event, however the user may elect to override this default on specific calendar events, as shown at 1302 and 1304 above in FIG. 13.

FIG. 20 shows an attendant options screen 2002 (similar to screen 1102) for configuring attendant options. The user enters an attendant's phone number at the top of the screen 2002, which can be added or removed by selecting appropriate buttons. In addition, the attendant can be given connection call permission, call control permission, or both, by selecting appropriate boxes. The user can also specify a number of seconds between receipt of the call and transfer to the attendant.

FIG. 21 shows an Outlook™ inbox screen 2100 and an active extension pull-down menu associated with the active extension button 2102. This pull-down menu allows the user to instantly change the extension currently active for incoming calls. As previously described, the extensions are handling codes. In the example of FIG. 21, the user is changing the current active extension from “20 My Office” to “30 Cellular”.

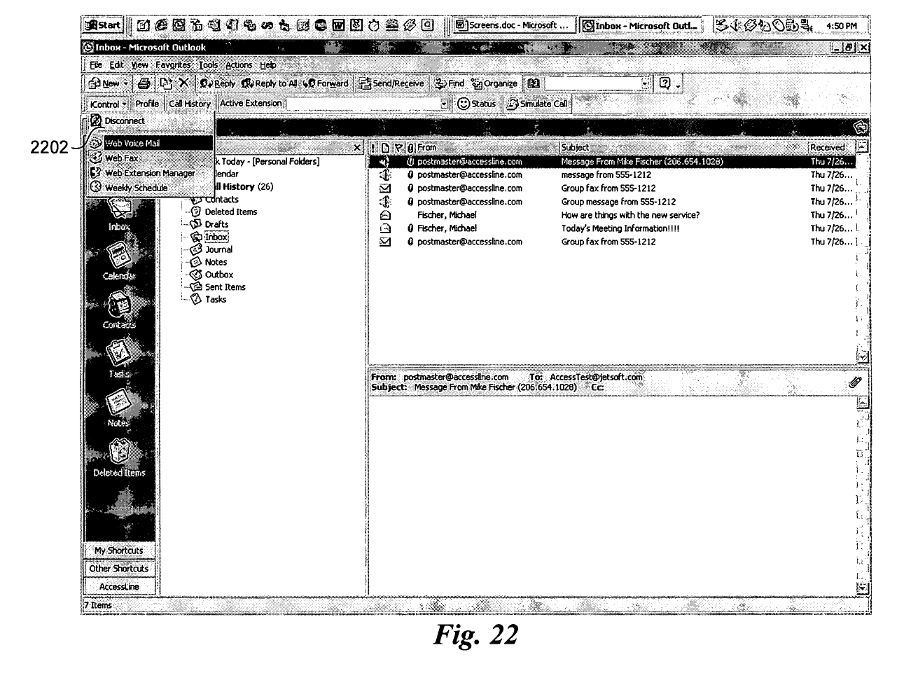

FIG. 22 shows a pull-down menu 2202 below the iControl button. The menu allows the user to disconnect from the communication management system. The menu 2202 further allows the user to link to a web site for accessing web voice mail, web fax service, a web extension manager, and a weekly default call-handling schedule by selecting the appropriate buttons (and thereby navigating to appropriate web sites based on associated URLs). The web voice mail site (not shown) displays a list of stored voice mail messages on which a user may click and replay over the user computer. The web fax mail site (not shown) and displays a list of stored fax mail messages on which a user may click and display on the user computer. The web extension manager site allows the user to configure call extensions, add extensions, and otherwise adjust call handling methods as described herein. The weekly schedule site allows a user to configure his or her default call handling schedule, as described herein.

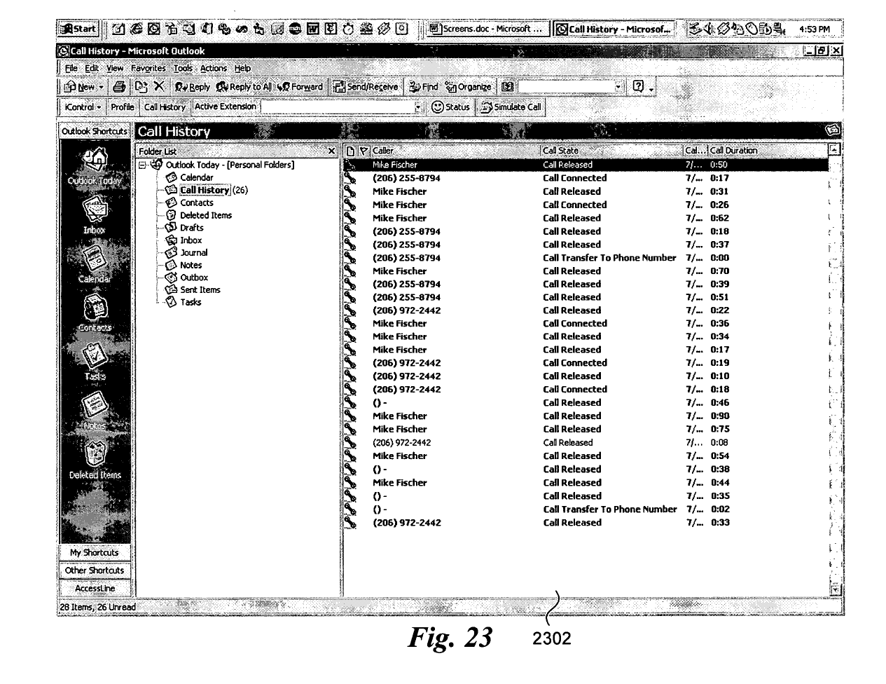

FIG. 23 shows an Outlook™ call history screen 2302 displayed when a user clicks the Call History button. The call history screen 2302 lists calls received, from whom received, duration, date, and call state. Since such calls are displayed under the Outlook application, a user may employ the functionality provided in Outlook. For example, the user may sort all calls displayed based on the caller, call states, call duration, etc. Likewise, a user may create folders and store listed calls inside such folders, move calls to other features under Outlook (e.g., the Journal, Contacts, Calendar), and the like.

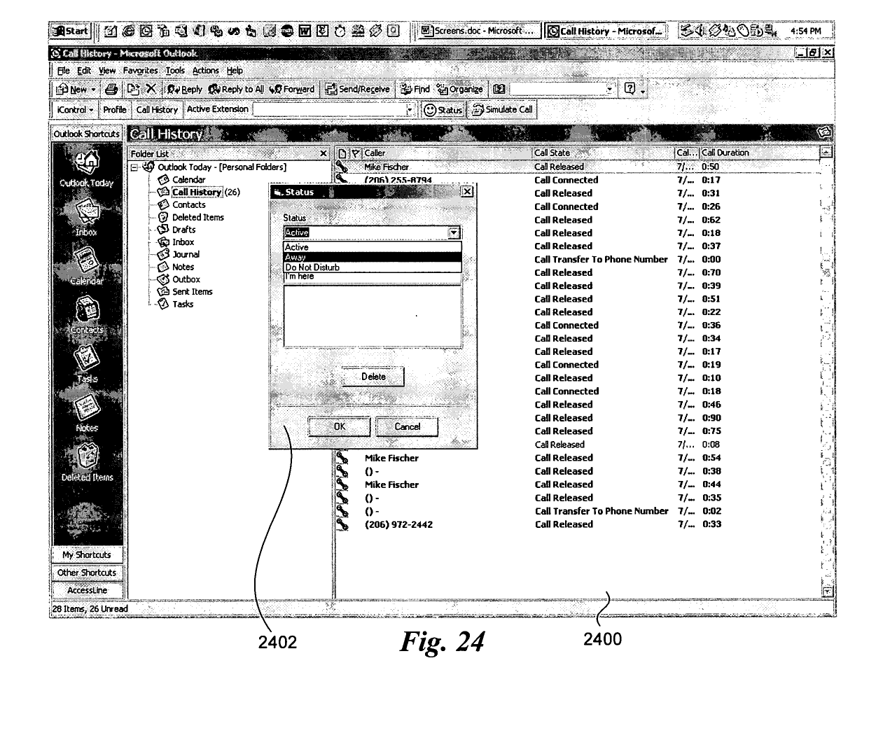

FIG. 24 shows an Outlook™ call history screen 2400 and a status screen 2402. The status screen 2402 appears when the “Status” button in the toolbar is clicked. The user can enter a current status to be used by the TSPS 103 in handling calls. Screen 2402 also allows the user to define “message text” to be associated with each status. For example the message text for Away might be “I'm out to lunch”. In the example shown in FIG. 24, the message text for the Active status is “I'm here”. The message text is seen by the attendant, for example by moving the mouse over the status icon associated with the user.

FIG. 25 shows an Outlook™ call history screen 2500 and a pop-up call screen 2502. In one configuration of the communication management system, the incoming call screen 2502 appears when an incoming call is received by the TSPS 103. The TSPS determines, using the registration server 106, information displayed on the screen 2502. The user has the option of “quick directing” the call to one of the three extensions shown, each of which represent a previously defined call handling code under screen 1902. The user may also open contact information for the caller that is stored in the Outlook™ contacts database. The call history screen 2500 displays the incoming call on the top line of the screen (“Paul Chen Incoming Call”).

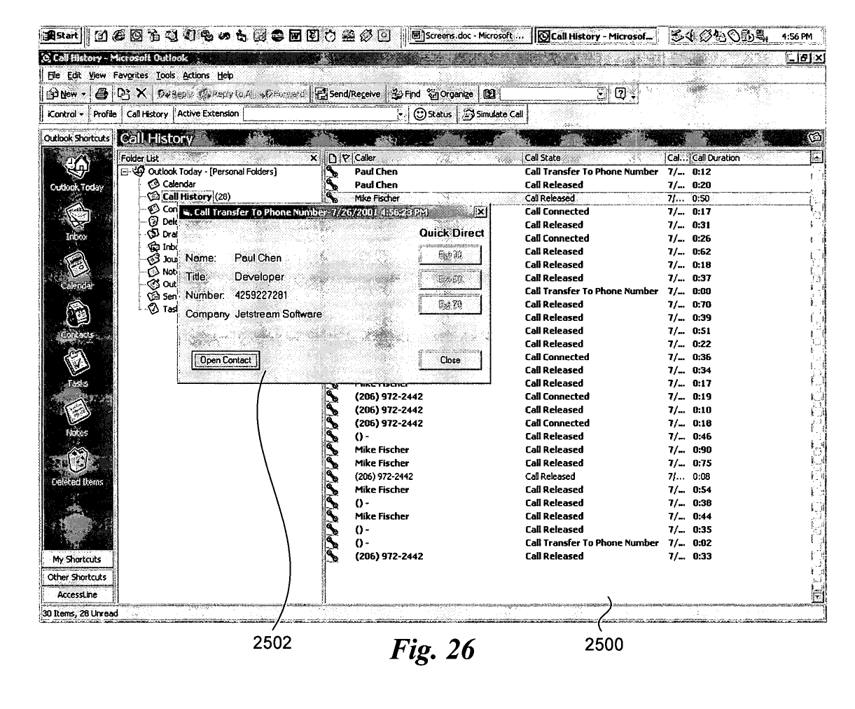

FIG. 26 shows the Outlook™ call history screen 2500 and the pop-up call screen 2502. The quick direct buttons are not available, indicating that the user has chosen one of the options already. The call history screen 2500 in FIG. 26 indicates on the top line that the call was transferred to a phone number (“Paul Chen Call Transfer to Phone Number . . . ”).

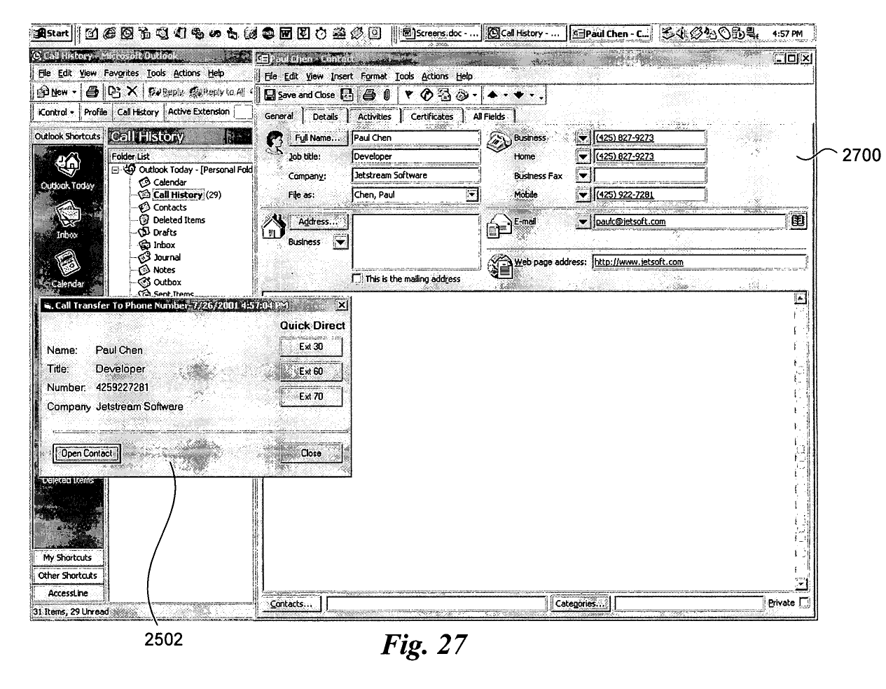

FIG. 27 shows an Outlook™ contact card 2700 and that may be displayed when the user selects an “Open Contact” button on the pop-up call screen 2502. The contact card 2700 shows relevant information for the incoming caller and allows the user to access other, related information. For example, the user may select an Activities tab for the displayed contact to show a list of activities associated with the contact. Likewise, the user may select the “Details”, “All Fields” or other tabs or options under Outlook to quickly access information regarding an incoming caller.

In one embodiment, the contact management software 114 provides a software event to the communications, registration, and user interface component 112, via interface component 113, whenever a new contact is created. The communications, registration, and user interface component 112, in turn, sends a software message back to the contact management software 114, instructing it to add a new data field associated with this contact, containing a unique contact identification key. The new contact is also transmitted to the contact info database 108. Upon receipt of a new incoming call, the registration server 106 searches the contact info database 108 for a match against the CLI of the incoming call. If a match is found, then the registration server 106 provides to the user computer 111 a TCP/IP message with the called number, callers information (name, title, etc., or just CLI), and the unique identification key to the user's Outlook contact database. In response, the communications, registration, and user interface component 112 causes window 2502 to pop-up, presenting the caller information. The “Open Contact” button on window 2502 is now related to the unique identification key. If the user presses this key, then component 112 sends a message via interface component 113 to contact management software 114 with this unique identification key, causing the corresponding contact window 2700 to appear.

The additional call handling functionality provided through Outlook™ may be provided as client software to be installed on the user computer 111. The user may download and install the client software from a web site associated with the TSPS. Once installed, the client software employs published APIs in Outlook™ to modify Outlook™'s standard user interface to include the buttons, menus and screens described above.

In another embodiment, the user may select an option on the notification window 2502 or 401 (option is not shown in the figure) causing the Telephony Service Provider System to record the subsequent conversation between the caller and the user. When the call is completed, the recorded conversation is automatically transmitted over the Internet 110 to the User's Computer 111 and stored in the Contact Management Software, associated with the contact related to the caller.

Many alternatives are possible under the invention described herein. For example, rather than employing separate fields within screens displayed by the user's contact and calendar management software (such as the fields 1302 and 1304 of FIG. 13), the system may use existing fields in such software for determining how to handle calls. For example, appointments under Outlook™ may be assigned any of the following appointment status fields: free, tentative, busy, out of office, or private. Based on the user's predefined call routing code, the system may route calls based upon these existing fields. For example, if an appointment is designated by the user as “private”, then all calls may be routed to the user's voicemail system (or secretary). However, if an appointment is designated by the user as “free”, then calls may be routed directly to the user, such as at the user's office phone or cellular phone. In general, the system creates a rules base that, based on user input, defines call screening or handling options for incoming calls. To handle calls, the system employs existing fields and data under the user's contact and calendar management software, or creates new fields for this software under APIs established for the software.

Calls may be routed under numerous user-defined methods. For example, the user may employ existing fields in the contact and calendar management software to define how calls are routed. For example, the user may employ the “Other” field under the contacts portion of Microsoft Outlook™ to define a user number, or client number, for one or more individuals listed in the user's contacts. The system may then store this field within the contact database, together with an associated call routing list. The call routing list is effectively a table listing in a first column client numbers, and in a second column associated assistant phone numbers for that client.

While calls may be routed based on one or more pop-up windows in which users enter data or click options (e.g. window 2502), the system may instead automatically route calls. Alternatively, the window 2502 may omit the “Open Contact” button and instead automatically open an appropriate contact card or other contact information. Thus, any relevant information stored in the contact database may be automatically displayed to a user when an associated incoming call is received. For example the system could be configured in such a way so that as an incoming call is received, the user would be automatically presented with the callers contact information, and a list of all messages to or from this caller, or all calendar events associated with this caller, or all documents associated with this caller, or any combination of these or similar items.

As describe in embodiments above, standard contact management or personal organizer software product, such as Microsoft Outlook or IBM Lotus Notes may be used, without modification to the standard product itself, in conjunction with a Telephony Service Provider System (TSPS), to provide a call handling system. A user may enter an additional piece of information for each of these contacts. This additional information indicates how calls should be handled if received from this contact. An interface software component, residing on the user's computer, reads the contact database from the user's contact management software. A communications, registration, and user interface software component, also residing on the user's computer, obtains the contact data from the interface component, and passes it over the Internet to a registration server system which holds this data in a contact info database to be used by the TSPS when providing call screening information for each user.

Under an alternative embodiment, this additional information may be in the form of an extra character inserted at the end of an appropriate field, for example the business phone number field for the contact. For example, if a “+” is inserted at the end of the phone number, then if a call is received for the user by the TSPS, then the TSPS will automatically route the call directly to the user's current phone number. However if a “−” is inserted at the end of the phone number field, then the call might be routed to voice mail. If there is no extra character inserted in the field, then the call might be handled according to a default call handling method, for example the caller might be prompted to “ . . . touch 0 if the call is important”, and if the caller touches 0 then the call will be routed to the users current phone number, and otherwise the call will be routed to voice mail.

In another embodiment, the additional information may be in the form of a numeric code inserted into an otherwise unused field in the contact database, such as in a “Other Phone Number” field. The numeric code would provide an indication of the appropriate call handling method for calls received from this caller. For example a “1” in this field might indicate to route all calls immediately to the users phone number, a “2” might indicate to route calls to voice mail, a “3” might indicate to route calls to the users secretary, a “4” might indicate that the TSPS should give the caller various menu choices before routing the call, a “5” might indicate to route calls to the user's cell phone, a “6” might indicate to route calls to the user's pager, a “7” might indicate to route calls to a particular predefined extension in a PBX system, and the like. Under a default option where no number is present in this field, the call is handled under a predetermined default method, such as being routed to a receptionist. In general, the system may employ any method of call routing, including those described in detail in U.S. Pat. Nos. 5,752,191, 5,694,453, 5,610,970, 5,588,037, 5,375,161, and 5,841,837.

In yet another embodiment, the additional information may be in the form of a phone number inserted into an available field in the contact database. This phone number would indicate the phone number to route the call, should a call be received from this contact.

In general, user input described herein may be of any form, not necessarily point and click or keyboard interaction with a web page using a computer input device, personal computer and web browser software. For example, user input may be of a graphical form (e.g., bitmapped, vector-based or matrix), or where such user input is provided to the user via an appropriate device, such as a palm top computer having a wireless connection to the system. Of course, dual-tone, multi-frequency (DTMF) or voice command using interactive voice response (IVR) input may be employed. Thus, user input by the user computer may be in any format, such as alphanumeric characters in ASCII or Unicode format, voice commands, graphical input, etc. Graphical input, for example, may represent shapes, or single stroke character input, e.g., drawn by a user on a palm top computer, where such bitmap or vector images are then transmitted to the server as user input.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “above”, “below” and words of similar import, when used in this application, shall refer to this application as a whole and not to any particular portions of this application.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the call routing system described herein. These and other changes can be made to the invention in light of the detailed description.

The elements and acts of the various embodiments described above can be combined to provide further embodiments. All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A method for managing communications from a user interface, the method comprising:
receiving user input to configure a telephony service provider system (TSPS), wherein configuration includes associating a handling method with each one of multiple call handling codes, wherein the handling method directs the TSPS in handling a call;
receiving user input to a contact management system associating at least some of multiple contacts stored in a contact management system database with one of the handling codes; and
receiving user input when a call is received that directs the TSPS how to handle a call, including contradicting a handling code previously associated with a contact, and wherein the TSPS interfaces with the contact management system and uses data from the contact management system database to handle calls.

2. The method of claim 1, wherein handling calls comprises:
routing calls to a previously specified location, including,
a phone number;
an interactive voice response system (IVR); and
a user computer, including displaying a notification window that displays at least one item selected from a group comprising a caller number, a caller name, and at least one forwarding button the user selects to forward the call to a number.

3. The method of claim 1, further comprising providing a notification window having an open contact button to request display of information associated with the caller from the contact management system.

4. The method of claim 1, further comprising displaying a notification window, including a display of information associated with the caller from the contact management system.

5. The method of claim 3, wherein the information includes:
email messages sent to the caller;
and email messages received from the caller;
calendar events that include the caller; and
documents that reference the caller.

6. The method of claim 5, wherein the email messages, calendar events, and documents meet specific criteria as configured by the user.

7. The method of claim 6, wherein the specific criteria includes a time and a date.

8. The method of claim 1, further comprising displaying a call history to a user that includes information regarding previous and current calls from a caller.

9. The method of claim 1, further comprising, in response to receiving a call, initiating a web chat session between at least two devices.

10. The method of claim 1, wherein configuration further comprises designating an attendant device to which calls are forwarded under certain circumstances, and designating the attendant device to monitor incoming calls to the TSPS on behalf of the user.

11. The method of claim 1, further comprising:
the TSPS receiving a call from a telephone system;
the TSPS determining a user identification (ID) from a called number;
the TSPS using a calling line identification (CLI) number and the user identification to find a handling code associated with the CLI number;
the TSPS using the user ID to find a current status of the user;
the TSPS using the user ID and the CLI number to access data from the contact management system database;
the TSPS using the user ID and the CLI number to access a user profiles database to determine a handling method for the call; and
the TSPS using the handling method, the current status of the user, the data, and the handling code to handle the call.

12. The method of claim 11, wherein the data includes contact data and calendar data.

13. A communication management system, comprising:
at least one user computer, including a storage device having standard contact management software stored thereon, including a contact management user interface, and a contact management database;
a telephony service provider system (TSPS) coupled to the at least one user computer through a network, and further coupled to at least one telephone network for receiving voice calls intended for a user of the at least one user computer, wherein the TSPS comprises,
an interface component that communicates with the contact management system;
at least one database that stores:
a user configuration for the user;
calendar information for the user associated with the contact management database;
contact information for the user stored from the contact management database; and
TSPS registration information for the user;
wherein the TSPS receives a voice call for the user and handles the voice call with reference to information in the at least one database, and wherein handling includes routing the call based at least upon contact information related to a caller that placed the call.

14. The system of claim 13, further comprising at least one attendant computer operated by an attendant, wherein the at least one attendant computer is coupled to the at least one user computer though a network, wherein the user configuration specifies:
that particular voice calls be forwarded to the attendant; and
the attendant has limited shared access to the TSPS, including monitoring and controlling the user's voice calls using the TSPS.

15. The system of claim 13, wherein the user configures the TSPS using the contact management user interface, and wherein the user further receives notification of voice calls using the contact management user interface, and responds to the notification in real-time using the contact management user interface.

16. The system of claim 15, wherein configuration includes storing a handling code in an unused portion of a data field in the contact management database to direct the TSPS in handling a voice call from a particular caller, and associating a handling method with the handling code in the at least one database of the TSPS.

17. The system of claim 13, wherein the TSPS is a one-number system.

18. The system of claim 13, wherein the interface component communicates with the contact management system via open application programming interfaces of the contact management system.

19. A method for handling incoming communications, comprising:
receiving at least one voice call intended for a recipient;
based on data related to the at least one voice call, accessing data regarding a caller that placed the at least one voice call, wherein the data regarding the caller includes data from a previously configured standard contact management system; and
handling the at least one voice call based on the data regarding the caller, wherein handling includes routing the at least one voice call to a particular destination, and notifying the recipient of the at least one voice call using at least one notification method.

20. The method of claim 19, wherein the at least one notification method includes displaying the at least one voice call in a window on a user interface of the contact management system, wherein the window includes buttons that allow the user to:
display information from the contact management database related to the caller;
display a call history that includes information related to past calls and to the at least one voice call; and
transfer the call to at least one destination.

21. The method of claim 19, wherein routing includes:
transferring the at least one voice call to a voice message service, wherein the voice message service prompts the caller to leave a message;
transferring the at least one voice call to a previously designated attendant;
transferring the at least one voice call to a previously designated current user location; and
playing one of at least one prompt that interacts with the caller via interactive voice response (IVR).

22. The method of claim 19, wherein the data from the previously configured standard contacts management system includes:
a phone number identifying a device that is presumed to be used by the caller, wherein the phone number occupies a field in a database of the contact management system; and
a handling code that occupies a field in the database of the contact management system, wherein the handling code has significance only for a telephony service provider system (TSPS) in communication with the contact management system.

23. The method of claim 22, further comprising communicating between the TSPS and the standard contact management system using application programming interfaces (APIs) of the standard contact management system, wherein communicating comprises:
storing contact information, including phone numbers and handling codes, in a contact information database that is directly accessible to the TSPS; and
receiving user configuration information for the TSPS through a user interface of the contact management system, including assignment of handling instructions to handling codes.

24. The method of claim 23, wherein communicating further comprises storing calendar information from the contact management system in a calendar events database that is directly accessible to the TSPS, and wherein the user configuration information further includes information regarding handling the at least one voice call based on the calendar information, including whether the at least one voice call is received during a calendared event.

25. A computer-readable medium, having stored thereon instructions, which when executed, cause at least one processor to:
receive user input to configure a telephony service provider system (TSPS), wherein configuration includes associating a handling method with each one of two or more call handling codes, wherein the two or more call handling codes correspond to directing the TSPS in handling a call under respective two or more call handling methods;
receive user input to a contact management system associating at least some of multiple contacts stored in a contact management system database with one of the handling codes;
in response to receiving a call, displaying a window that provides information from the contract management system regarding a likely caller associated with the call; and
receive user input when the call is received that directs the TSPS to handle the received call, wherein the TSPS uses data from the contact management system database to handle the received call.

26. The computer-readable medium of claim 25, further comprising:
routing calls to a previously specified location, including,
a phone number; and
a user computer, including displaying a notification window that includes a caller name, a caller number, and at least one forwarding button the user selects to forward the call to a number.

27. The computer-readable medium of claim 26, the displayed window includes an open contact button the user may select to display information about the caller from the contact management system.

28. The computer-readable medium of claim 26, further comprising displaying a call history that includes information regarding previous and current calls from a caller.

29. The computer-readable medium of claim 26, further comprising, in response to receiving the call, initiating a web chat session between at least two devices.

30. The computer-readable medium of claim 25, further comprising designating an attendant device to which received calls are forwarded under certain circumstances, and designating the attendant device to monitor incoming calls to the TSPS on behalf of the user.

31. The computer-readable medium of claim 25 wherein the computer-readable medium is a logical node in a computer network receiving the contents.

32. The computer-readable medium of claim 25 wherein the computer-readable medium is a computer-readable disk.

33. The computer-readable medium of claim 25 wherein the computer-readable medium is a data transmission medium transmitting a generated data signal containing the contents.

34. The computer-readable medium of claim 25 wherein the computer-readable medium is a memory of a computer system.

35. A call handling system, comprising:
a standard contact management application, wherein the standard contact management application includes a database of contact information,
wherein the contact information includes names of contacts and telephone numbers associated with the contacts, and
wherein the standard contact management application further includes a set of published application program interfaces (APIs) for accessing functionality in the standard contact management application;
a call management application, wherein the call management application is configured to
receive information regarding an incoming call, including an originating phone number,
employ at least some of the set of APIs in the standard contact management application to provide at least a name from the contact information in the database based on the originating phone number; and
provide at least two different call handling options to the user for handling the incoming call.

36. A computer-implemented method for use with a standard contact management application, wherein the standard contact management application stores and displays contact information, the method comprising:
receiving an incoming voice telephone call, wherein the incoming call includes information associated with an originating telephone number;
accessing one of many contact records in the standard contact management application based on the information associated with an originating telephone number; and
automatically causing at least some information associated with the one contact record to be displayed for a user.
